(19) United States
(12) Patent Application Publication
(10) Pub. No.: US 2019/0034080 A1
(43) Pub. Date: Jan. 31, 2019

(54) AUTOMATIC TRANSLATIONS BY A KEYBOARD

(71) Applicant: GOOGLE LLC, Mountain View, CA (US)

(72) Inventors: Jens Nagel, Sunnyvale, CA (US); Song Fu, Beijing (CN)

(21) Appl. No.: 15/102,420

(22) PCT Filed: Apr. 20, 2016
(86) PCT No.: PCT/CN2016/079719

§ 371 Date: Jun. 7, 2016

(51) Int. Cl. G06F 3/0488; G06F 17/28; G06F 3/0482

(52) U.S. Cl. CPC G06F 3/04886; G06F 3/0482; G06F 17/289

(57) ABSTRACT

A mobile computing device is described that outputs, for display at a presence-sensitive display component, a graphical user interface that includes an edit region and a graphical keyboard including a plurality of keys and a translation region. The device determines one or more keys from the plurality of keys selected by an input, determines, based on the one or more keys, one or more candidate words from a source language, and outputs, for display, within the edit region, an indication of at least one candidate word from the one or more candidate words. The device determines a translation of a particular word from the at least one candidate word that is associated with a destination language that is different than the source language, and outputs, for display within the translation region, an indication of the translation of the particular word.

### BACKGROUND

Despite being able to simultaneously execute several applications, some mobile computing devices can only present a single application graphical user interface (GUI) at a time. To interact with multiple applications at once, a user of a mobile computing device may have to provide several inputs to switch between different application GUIs to complete a particular task. For example, if a user of a mobile computing device is typing a message from within a messaging application GUI using a graphical keyboard and he or she needs to translate a word, the user may need to provide several inputs to: switch to a translation application GUI, cause the translation application to translate the word, copy the translation to a memory clipboard, switch back to the messaging application GUI, and paste the translation from the clipboard and into the message. Providing the several inputs required by some computing devices to perform translations can be tedious, repetitive, and time consuming.

### SUMMARY

In one example, a method includes outputting, by a computing device, for display, a graphical user interface that includes a graphical keyboard and an edit region, the graphical keyboard comprising a plurality of keys and a translation region, determining, by the computing device, based on a selection of one or more keys from the plurality of keys, one or more candidate words from a source language, and outputting, by the computing device, for display within the edit region, an indication of at least one candidate word from the one or more candidate words. The method further includes determining, by the computing device, a translation of a particular word from the at least one candidate word, the translation of the particular word being associated with a destination language that is different than the source language, and outputting, by the computing device, for display within a translation region of the graphical keyboard, an indication of the translation of the particular word.

In another example, a mobile computing device that includes a presence-sensitive display component, at least one processor, and a memory. The memory stores instructions that when executed cause the at least one processor to: output, for display at the presence-sensitive display component, a graphical user interface that includes a graphical keyboard and an edit region, the graphical keyboard comprising a plurality of keys and a translation region. The instructions, when executed, further cause the at least one processor to receive an indication of input detected at the presence-sensitive display component, determine one or more keys from the plurality of keys selected by the input, determine, based on the one or more keys, one or more candidate words from a source language, output, for display at the presence-sensitive display component and within the edit region, an indication of at least one candidate word from the one or more candidate words, determine a translation of a particular word from the at least one candidate word, the translation of the particular word being associated with a destination language that is different than the source language, and output, for display at the presence-sensitive display component and within the translation region, an indication of the translation of the particular word.

In another example, a computer-readable storage medium encoded with instructions that, when executed by at least one processor of a computing device, cause the at least one processor to output, for display, a graphical user interface that includes an edit region and a graphical keyboard, the graphical keyboard comprising a plurality of keys and a translation region, and while receiving an indication of a selection of one or more keys from the plurality of keys, output, for display within the region, one or more candidate words inferred from the selection, wherein the one or more candidate words are associated with a source language. The instructions, when executed, further cause the at least one processor to determine a translation of a particular word from the one or more candidate words, the translation of the particular word being associated with a destination language that is different than the source language, and output, for display within the translation region, an indication of the translation.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A-1C are conceptual diagrams illustrating an example computing device that is configured to present a graphical keyboard with integrated translation features, in accordance with one or more aspects of the present disclosure.

FIG. 2 is a block diagram illustrating an example computing device that is configured to present a graphical keyboard with integrated translation features, in accordance with one or more aspects of the present disclosure.

FIG. 3 is a block diagram illustrating an example computing device that outputs graphical content for display at a remote device, in accordance with one or more techniques of the present disclosure.

FIGS. 4A-4I are conceptual diagrams illustrating example graphical user interfaces of an example computing device that is configured to present a graphical keyboard with integrated translation features, in accordance with one or more aspects of the present disclosure.

FIG. 5 is a flowchart illustrating example operations of a computing device that is configured to present a graphical keyboard with integrated translation features, in accordance with one or more aspects of the present disclosure.

### DETAILED DESCRIPTION

In general, this disclosure is directed to techniques for enabling a computing device to perform real-time translations of words being entered with a graphical keyboard and display the translations within the graphical keyboard. For example, as a computing device detects input at a graphical keyboard of a graphical user interface (GUI), the computing device may infer that a user may wish to translate a word, determined from the input, to a second language. Without requiring any additional input from the user, the computing device may automatically determine the second language that the user may wish to translate, and automatically translate the word from a first language to the second language that is different than the first language. The device may output a graphical indication of the translation for display within the graphical keyboard. In some examples, responsive to detecting input associated with the graphical indication of the translation, the computing device may replace the original word entered in the first language with the translation of the word in the second language.

By providing a graphical keyboard with automatic second language detection and integrated translation, the user may automatically obtain selectable translations of words within the graphical keyboard, as the user is typing, rather than requiring the user to switch between different application GUIs to enter text in a non-native language. In this way, techniques of this disclosure may reduce the number of user inputs required to perform multi-lingual text-entry, which may simplify the user experience and may reduce power consumption of the computing device.

Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

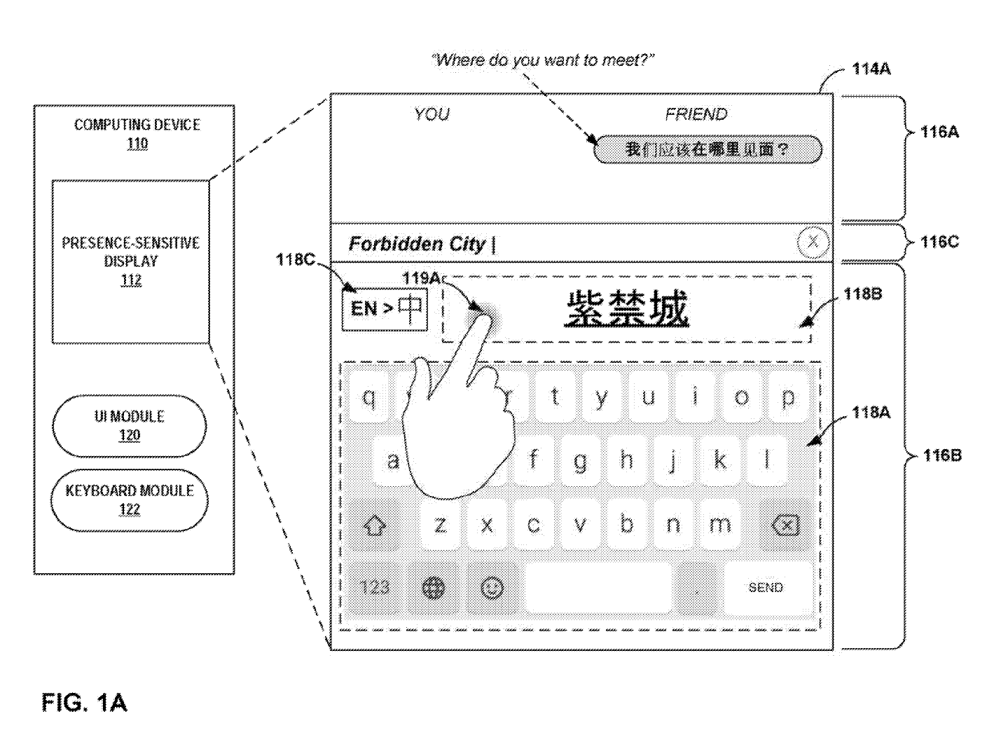

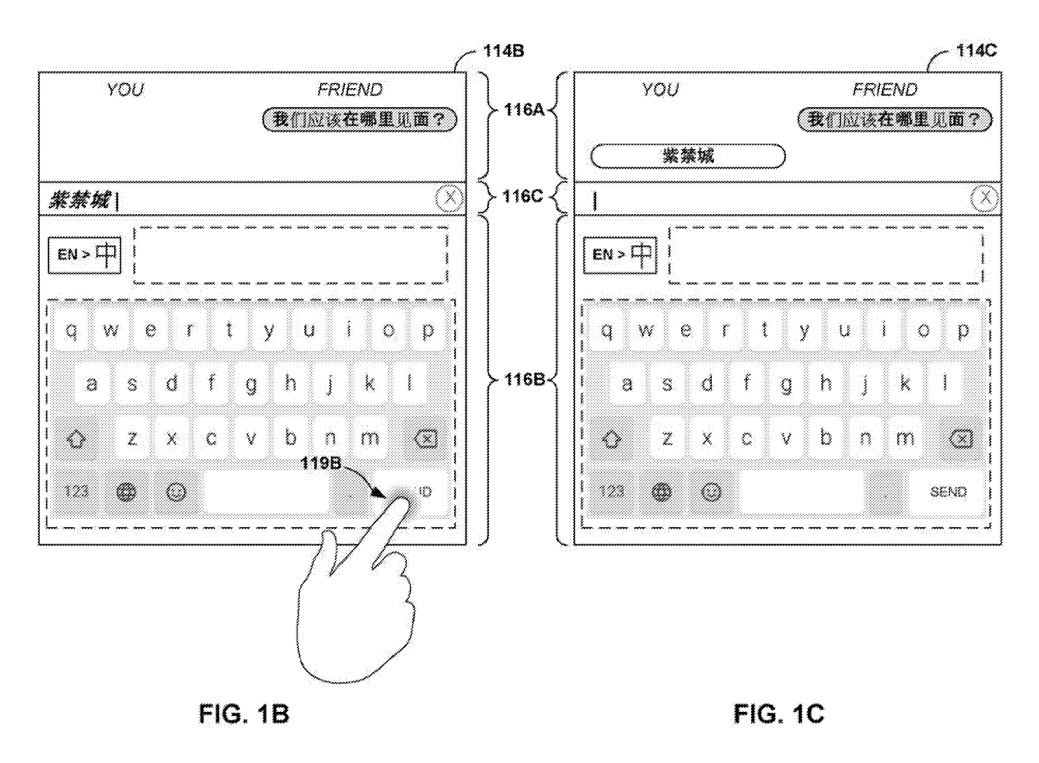

FIGS. 1A-1C are conceptual diagrams illustrating an example computing device 110 that is configured to present a graphical keyboard with integrated translation features, in accordance with one or more aspects of the present disclosure. Computing device 110 may represent a mobile device, such as a smart phone, a tablet computer, a laptop computer, computerized watch, computerized eyewear, computerized gloves, or any other type of portable computing device. Additional examples of computing device 110 include desktop computers, televisions, personal digital assistants (PDA), portable gaming systems, media players, e-book readers, mobile television platforms, automobile navigation and entertainment systems, vehicle (e.g., automobile, aircraft, or other vehicle) cockpit displays, or any other types of wearable and non-wearable, mobile or non-mobile computing devices that may output a graphical keyboard for display.

Computing device 110 includes a presence-sensitive display (PSD) 112, user interface (UI) module 120 and keyboard module 122. Modules 120 and 122 may perform operations described using software, hardware, firmware, or a mixture of hardware, software, and firmware residing in and/or executing at computing device 110. One or more processors of computing device 110 may execute instructions that are stored at a memory or other non-transitory storage medium of computing device 110 to perform the operations of modules 120 and 122. Computing device 110 may execute modules 120 and 122 as virtual machines executing on underlying hardware. Modules 120 and 122 may execute as one or more services of an operating system or computing platform. Modules 120 and 122 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may detect input (e.g., touch and non-touch input) from a user of respective computing device 110. PSD 112 may detect indications of input by detecting one or more gestures from a user (e.g., the user touching, pointing, and/or swiping at or near one or more locations of PSD 112 with a finger or a stylus pen). PSD 112 may output information to a user in the form of a user interface (e.g., user interfaces 114A-114C), which may be associated with functionality provided by computing device 110. Such user interfaces may be associated with computing platforms, operating systems, applications, and/or services executing at or accessible from computing device 110 (e.g., electronic message applications, chat applications, Internet browser applications, mobile or desktop operating systems, social media applications, electronic games, and other types of applications). For example, PSD 112 may present user interfaces 114A-114C (collectively referred to as “user interfaces 114”) which, as shown in FIGS. 1A-1C, are graphical user interfaces of a chat application executing at computing device 110 and includes various graphical elements displayed at various locations of PSD 112.

As shown in FIGS. 1A-1C, user interfaces 114 are chat user interfaces, however user interfaces 114 may be any graphical user interface which includes a graphical keyboard with integrated translation features. User interfaces 114 include output region 116A, graphical keyboard 116B, and edit region 116C. A user of computing device 110 may provide input at graphical keyboard 116B to produce textual characters within edit region 116C that form the content of the electronic messages displayed within output region 116A. The messages displayed within output region 116A form a chat conversation between a user of computing device 110 and a user of a different computing device.

UI module 120 manages user interactions with PSD 112 and other components of computing device 110. In other words, UI module 120 may act as an intermediary between various components of computing device 110 to make determinations based on user input detected by PSD 112 and generate output at PSD 112 in response to the user input. UI module 120 may receive instructions from an application, service, platform, or other module of computing device 110 to cause PSD 112 to output a user interface (e.g., user interfaces 114). UI module 120 may manage inputs received by computing device 110 as a user views and interacts with the user interface presented at PSD 112 and update the user interface in response to receiving additional instructions from the application, service, platform, or other module of computing device 110 that is processing the user input.

Keyboard module 122 represents an application, service, or component executing at or accessible to computing device 110 that provides computing device 110 with a graphical keyboard having integrated translation features. Keyboard module 122 may switch between operating in text-entry mode in which keyboard module 122 functions similar to a traditional graphical keyboard, or translation mode in which keyboard module 122 performs various integrated translation functions.

In some examples, keyboard module 122 may be a stand-alone application, service, or module executing at computing device 110 and, in other examples, keyboard module 122 may be a sub-component thereof. For example, keyboard module 122 may be integrated into a chat or messaging application executing at computing device 110 whereas, in other examples, keyboard module 122 may be a stand-alone application or subroutine that is invoked by an application or operating platform of computing device 110 any time an application or operating platform requires graphical keyboard input functionality. In some examples, computing device 110 may download and install keyboard module 122 from an application distribution platform (e.g., via the Internet) such as an application repository of a service provider. In other examples, keyboard module 122 may be preloaded during production of computing device 110.

When operating in text-entry mode, keyboard module 122 of computing device 110 may perform traditional, graphical keyboard operations used for text-entry, such as: generating a graphical keyboard layout for display at PSD 112, mapping detected inputs at PSD 112 to selections of graphical keys, determining characters based on selected keys, or predicting or autocorrecting words and/or phrases based on the characters determined from selected keys.

Graphical keyboard 116B includes graphical elements displayed as graphical keys 118A. Keyboard module 122 may output information to UI module 120 that specifies the layout of graphical keyboard 116B within user interfaces 114. For example, the information may include instructions that specify locations, sizes, colors, and other characteristics of graphical keys 118A. Based on the information received from keyboard module 122, UI module 120 may cause PSD 112 display graphical keyboard 116B as part of user interfaces 114.

Each key of graphical keys 118A may be associated with a respective character (e.g., a letter, number, punctuation, or other character) displayed within the key. A user of computing device 110 may provide input at locations of PSD 112 at which one or more of graphical keys 118A are displayed to input content (e.g., characters, search results, etc.) into edit region 116C (e.g., for composing messages that are sent and displayed within output region 116A or for inputting a search query that computing device 110 executes from within graphical keyboard 116B). Keyboard module 122 may receive information from UI module 120 indicating locations associated with input detected by PSD 112 that are relative to the locations of each of the graphical keys. Using a spatial and/or language model, keyboard module 122 may translate the inputs to selections of keys and characters, words, and/or phrases.

For example, PSD 112 may detect user inputs as a user of computing device 110 provides the user inputs at or near a location of PSD 112 where PSD 112 presents graphical keys 118A. UI module 120 may receive, from PSD 112, an indication of the user input detected by PSD 112 and output, to keyboard module 122, information about the user input. Information about the user input may include an indication of one or more touch events (e.g., locations and other information about the input) detected by PSD 112.

Based on the information received from UI module 120, keyboard module 122 may map detected inputs at PSD 112 to selections of graphical keys 118A, determine characters based on selected keys 118A, and predict or autocorrect words and/or phrases determined based on the characters associated with the selected keys 118A. For example, keyboard module 122 may include a spatial model that may determine, based on the locations of keys 118A and the information about the input, the most likely one or more keys 118A being selected. Responsive to determining the most likely one or more keys 118A being selected, keyboard module 122 may determine one or more characters, words, and/or phrases. For example, each of the one or more keys 118A being selected from a user input at PSD 112 may represent an individual character or a keyboard operation. Keyboard module 122 may determine a sequence of characters selected based on the one or more selected keys 118A. In some examples, keyboard module 122 may apply a language model to the sequence of characters to determine one or more the most likely candidate letters, morphemes, words, and/or phrases that a user is trying to input based on the selection of keys 118A.

Keyboard module 122 may send the sequence of characters and/or candidate words and phrases to UI module 120 and UI module 120 may cause PSD 112 to present the characters and/or candidate words determined from a selection of one or more keys 118A as text within edit region 116C. In some examples, when functioning as a traditional keyboard for performing text-entry operations, and in response to receiving a user input at graphical keys 118A (e.g., as a user is typing at graphical keyboard 116B to enter text within edit region 116C), keyboard module 122 may cause UI module 120 to display the candidate words and/or phrases as one or more selectable spelling corrections and/or selectable word or phrase suggestions within suggestion region 118B.

In addition to performing traditional, graphical keyboard operations used for text-entry, keyboard module 122 of computing device 110 also provides integrated translation capability. That is, rather than requiring a user of computing device 110 to navigate away from user interface 114A which provides graphical keyboard 116B (e.g., to a different application or service executing at or accessible from computing device 110), keyboard module 122 may operate in translation mode in which keyboard module 122 may execute translation operations and present translations of words being entered using graphical keyboard 116B within the same region of PSD 112 at which graphical keyboard 116B is displayed. As described herein, region 118B may be referred to as “suggestion region” 118B when keyboard module 122 is operating in traditional text-entry mode and may be referred to as “translation region” 118B when keyboard module 122 is operating in translation mode.

As indicated above, keyboard module 122 may execute as a stand-alone application, service, or module executing at computing device 110 or as a single, integrated sub-component thereof. Therefore, if keyboard module 122 forms part of a chat or messaging application executing at computing device 110, keyboard module 122 may provide the chat or messaging application with text-entry capability as well as translation capability. Similarly, if keyboard module 122 is a stand-alone application or subroutine that is invoked by an application or operating platform of computing device 110, any time an application or operating platform requires graphical keyboard input functionality, keyboard module 122 may provide the invoking application or operating platform with text-entry capability as well as translation capability.

Keyboard module 122 may further operate in translation mode. In some examples, when operating in translation mode, keyboard module 122 may cause graphical keyboard 116B to include translation element 118C. Translation element 118C represents a selectable element of graphical keyboard 116B for invoking one or more of the various translation features of graphical keyboard 116B. For example, by selecting translation element 118C (e.g., by tapping or gesturing at a location or within a region of PSD 112 at which search element 118C is displayed), a user can cause computing device 110 to begin translating words keyboard module 122 determines from input at graphical keys 118A or to perform other various integrated translation features provided by keyboard module 122 which do not require the user to navigate to a separate application, service, or other feature executing at or accessible from computing device 110.

For example, UI module 120 may output information to keyboard module 122 indicating that a user of computing device 110 may have selected selectable element 118C. Responsive to determining that element 118C was selected, keyboard module 122 may transition to operating in translation mode. While operating in translation mode, keyboard module 122 may reconfigure graphical keyboard 116B to execute translation functions in addition to, or as opposed to, other operations that are primarily attributed to traditional, single language text entry.

For example, keyboard module 122 may reconfigure suggestion region 118B to operate as a translation region that is configured to display graphical indications of translations as selectable elements. The graphical indications of translations may be destination language translations of source language words that keyboard module 122 originally derived from a language model, lexicon, or dictionary associated with the source language. For example, if the source language is English and the destination language is traditional Chinese, then rather than, or in addition to, provide English spelling or word suggestions within suggestion region 118B, computing device 110 may include, within suggestion region 118B, the equivalent suggested spelling or word suggestion in Chinese.

In operation, a user may rely on computing device 110 to exchange text messages with a device that is associated with a friend. The user may be a native English speaker and the friend may primarily speak traditional Chinese. From time to time, the user may try to impress his friend by speaking traditional Chinese. Keyboard module 122 may learn, overtime, from content of messages exchanged by computing device 110 and other computing devices, that the primary language used by the user or the “source language” of the messages is typically English (e.g., the user typically types and receives English language messages) and sometimes, the secondary language used by the user or the “destination language” is traditional Chinese (e.g., on occasion the user may send or receive a message written in traditional Chinese).

As shown in FIG. 1A, computing device 110 may receive a message from the device associated with the friend that states, in traditional Chinese, “where do you want to meet?” Computing device 110 may output user interface 114A for display which includes a message bubble with the message received from the device associated with the friend.

After viewing the message displayed at PSD 112, the user of computing device 110 may provide input to select keys 118A to compose a reply message, for instance, by gesturing at or near locations of PSD 112 at which keys 118A are displayed. Computing device 110 may determine, based on a selection of one or more keys 118A, one or more candidate words from a source language. For example, as the user of computing device provides input at keys 118A, keyboard module 122 may receive an indication of the input from UI module 120 and determine from the input, a selection of the keys 118A. Using a spatial and/or language model associated with the English language, keyboard module 122 may determine, based on the selection, that the user likely inputted the words “Forbidden City”.

Computing device 110 may output, for display within edit region 116C, textual characters “Forbidden City” as an indication of the candidate word that computing device 110 derived from the user input. For example, keyboard module 122 may send information to UI module 120 causing UI module 120 to present the text “Forbidden City” within edit region 116C.

Computing device 110 may determine a translation of the candidate word that is associated with a destination language that is different than the source language. For example, to impress the friend, the user may provide input at selectable element 118C to cause keyboard module 122 to provide a translation of the words “Forbidden City”. Responsive to receiving, from UI module 120, an indication of an input at a location of PSD 112 that is associated with selectable element 118C, keyboard module 122 may transition to operating in translation mode and translate the word determined from the selection of graphical keys 118A. For example, using a traditional Chinese language model (e.g., a dictionary, or other more sophisticated model), keyboard module 122 may determine a translation the English words or phrase “Forbidden City” as being [symbol] in traditional Chinese.

Computing device 110 may output, for display within translation region 118B, an indication of the translation of the particular word. For example, keyboard module 122 may output information to UI module 120 that causes UI module 120 to display the traditional Chinese characters [symbol] as text within translation region 118B.

After displaying the translation within translation region 118B, computing device 110 may register user input 119A as the user of computing device 110 selects the translation for subsequent input within edit region 116C. For example, keyboard module 122 may receive information from UI module 120 indicating that input 119A (e.g., a tap gesture) was detected at a location of PSD 112 at which translation region 118B is displayed and in response, send to UI module 120 information (e.g., instructions) for causing UI module 120 to replace the text “Forbidden City” with the text [symbol] .

As shown in FIG. 1B, after replacing a candidate word in edit region 116C with a translation of the candidate word, computing device 110 may detect input 119B (e.g., a tap gesture) at the “SEND” key of keys 118A. For example, UI module 120 may determine that PSD 112 detected input 119B at or near a location at which PSD 112 presents the “SEND” key of graphical keyboard 116B of user interface 114B.

As shown in FIG. 1C, computing device 110 may output the content of edit region 116C as a message to the device associate with the friend and may display the message within output region 116A. For example, UI module 120 may send information to the chat application associated with user interfaces 114C and the chat application may package the contents of edit region 116C into an electronic message format and cause computing device 110 to send the electronic message to the device associated with the friend. While sending the electronic message, the chat application may cause UI module 120 to present a graphical indication of the electronic message at output region 116A.

By providing a graphical keyboard with integrated translation features, the user of an example computing device may automatically obtain selectable translations of words within the graphical keyboard, as the user is typing, rather than requiring the user to switch between different application GUIs to enter text in a non-native language. For example, by providing a graphical keyboard with integrated translation features, an example computing device may eliminate the need for a user may to provide several inputs to switch between multiple GUIs and/or perform copy and paste operations to insert a translation of a word into a message. In this way, techniques of this disclosure may reduce the number of user inputs and therefore increase the speed with which a user can perform multi-lingual text-entry, which may simplify the user experience and may reduce power consumption of the computing device.

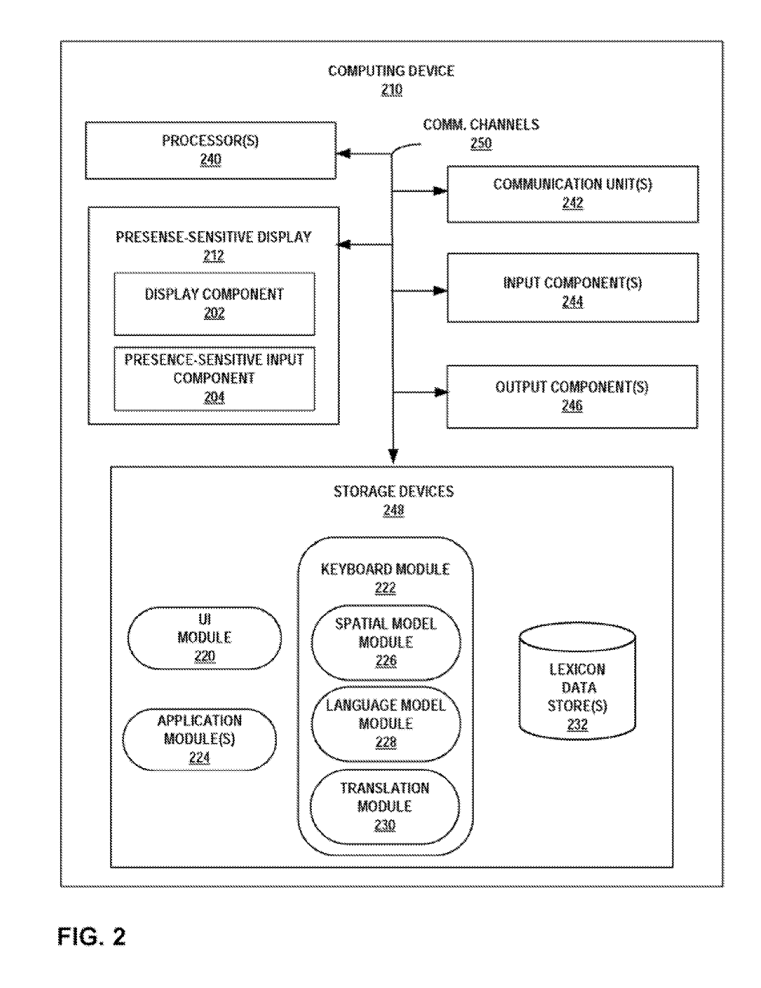

FIG. 2 is a block diagram illustrating computing device 210 as an example computing device that is configured to present a graphical keyboard with integrated translation features, in accordance with one or more aspects of the present disclosure. Computing device 210 of FIG. 2 is described below as an example of computing device 110 of FIGS. 1A-1C. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes PSD 212, one or more processors 240, one or more communication units 242, one or more input components 244, one or more output components 246, and one or more storage components 248. Presence-sensitive display 212 includes display component 202 and presence-sensitive input component 204. Storage components 248 of computing device 210 include UI module 220, keyboard module 222, one or more application modules 224, and one or more lexicon data stores 232. Keyboard module 122 may include spatial model (“SM”) module 226, language model (“LM”) module 228, and translation module 230. Communication channels 250 may interconnect each of the components 212, 240, 242, 244, 246, 248, 226, 228, and 230 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine. In some examples, input components 242 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., microphone, camera, infrared proximity sensor, hygrometer, and the like). Other sensors may include a heart rate sensor, magnetometer, glucose sensor, hygrometer sensor, olfactory sensor, compass sensor, step counter sensor, to name a few other non-limiting examples.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

PSD 212 of computing device 210 may be similar to PSD 112 of computing device 110 and includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD 212 may present a user interface (such as graphical user interfaces 114 of FIGS. 1A-1C).

While illustrated as an internal component of computing device 210, PSD 212 may also represent an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 240 include application processors, display controllers, auxiliary processors, one or more sensor hubs, and any other hardware configure to function as a processor, a processing unit, or a processing device. Modules 220, 222, 224, 226, 228, and 230 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 226, 228, and 230. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, 228, and 230 during execution at computing device 210). For example, one or more storage components 248 may store linguistic information at lexicon data stores 232 that keyboard module 222 uses to determine candidate words and translations of candidate words based on inputs at a graphical keyboard.

In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, 228, and 230. Storage components 248 may include a memory configured to store data or other information associated with modules 220, 222, 224, 226, 228, and 230.

UI module 220 may include all functionality of UI module 120 of computing device 110 of FIGS. 1A-1C and may perform similar operations as UI module 120 for managing a user interface (e.g., user interfaces 114) that computing device 210 provides at presence-sensitive display 212 for handling input from a user. For example, UI module 220 of computing device 210 may query keyboard module 222 for a keyboard layout (e.g., an English language QWERTY keyboard, etc.). UI module 220 may transmit a request for a keyboard layout over communication channels 250 to keyboard module 222. Keyboard module 222 may receive the request and reply to UI module 220 with data associated with the keyboard layout. UI module 220 may receive the keyboard layout data over communication channels 250 and use the data to generate a user interface. UI module 220 may transmit a display command and data over communication channels 250 to cause PSD 212 to present the user interface at PSD 212.

In some examples, UI module 220 may receive an indication of one or more user inputs detected at PSD 212 and may output information about the user inputs to keyboard module 222. For example, PSD 212 may detect a user input and send data about the user input to UI module 220. UI module 220 may generate one or more touch events based on the detected input. A touch event may include information that characterizes user input, such as a location component (e.g., [x,y] coordinates) of the user input, a time component (e.g., when the user input was received), a force component (e.g., an amount of pressure applied by the user input), or other data (e.g., speed, acceleration, direction, density, etc.) about the user input.

Based on location information of the touch events generated from the user input, UI module 220 may determine that the detected user input is associated the graphical keyboard. UI module 220 may send an indication of the one or more touch events to keyboard module 222 for further interpretation. Keyboard module 22 may determine, based on the touch events received from UI module 220, that the detected user input represents an initial selection of one or more keys of the graphical keyboard.

Application modules 224 represent all the various individual applications and services executing at and accessible from computing device 210 that may rely on a graphical keyboard having integrated search features. A user of computing device 210 may interact with a graphical user interface associated with one or more application modules 224 to cause computing device 210 to perform a function. Numerous examples of application modules 224 may exist and include, a fitness application, a calendar application, a personal assistant or prediction engine, a search application, a map or navigation application, a transportation service application (e.g., a bus or train tracking application), a social media application, a game application, an e-mail application, a chat or messaging application, an Internet browser application, or any and all other applications that may execute at computing device 210.

Keyboard module 222 may include all functionality of keyboard module 122 of computing device 110 of FIGS. 1A-1C and may perform similar operations as keyboard module 122 for providing a graphical keyboard having integrated search features. Keyboard module 222 may include various submodules, such as SM module 226, LM module 228, and search module 230, which may perform the functionality of keyboard module 222.

SM module 226 may receive one or more touch events as input, and output a character or sequence of characters that likely represents the one or more touch events, along with a degree of certainty or spatial model score indicative of how likely or with what accuracy the one or more characters define the touch events. In other words, SM module 226 may infer touch events as a selection of one or more keys of a keyboard and may output, based on the selection of the one or more keys, a character or sequence of characters.

When keyboard module 222 operates in text-entry mode or translate mode, LM module 228 may receive a character or sequence of characters as input, and output one or more candidate characters, words, or phrases that LM module 228 identifies from a lexicon (e.g., a dictionary) as being potential replacements for a sequence of characters that LM module 228 receives as input for a given language context (e.g., a sentence in a written language). Keyboard module 222 may cause UI module 220 to present one or more of the candidate words at suggestion region 118B of user interfaces 114.

Lexicon data stores 232 may include multiple lexicons (e.g., dictionaries) of various possible source and destination languages used by keyboard module 222 for performing traditional text-entry as well as translation operations. Each lexicon stored at data stores 232 may include a list of words within a written language vocabulary (e.g., a dictionary). For instance, the lexicon may include a database of words (e.g., words in a standard dictionary and/or words added to a dictionary by a user or computing device 210). LM module 228 may perform a lookup in a lexicon of lexicon data stores 232, of a character string, to identify one or more letters, words, and/or phrases that include parts or all of the characters of the character string.

For example, LM module 228 may assign a language model probability or a similarity coefficient (e.g., a Jaccard similarity coefficient) to one or more candidate words located at a lexicon of computing device 210 that include at least some of the same characters as the inputted character or sequence of characters. The language model probability assigned to each of the one or more candidate words indicates a degree of certainty or a degree of likelihood that the candidate word is typically found positioned subsequent to, prior to, and/or within, a sequence of words (e.g., a sentence) generated from text input detected by presence-sensitive input component 204 prior to and/or subsequent to receiving the current sequence of characters being analyzed by LM module 228. In response to determining the one or more candidate words, LM module 228 may output the one or more candidate words from lexicon data stores 260A that have the highest similarity coefficients.

Translation module 230 of keyboard module 222 may perform integrated translation functions on behalf of keyboard module 222. That is, when invoked (either automatically in response to keyboard module 222 determining that a user of computing device 210 may wish to translate a candidate word or manually in response to an explicit user input commanding computing device 210 to begin translating) translation module 230 may cause keyboard module 222 to reconfigure suggestion region 118B to function as translation region 118B from which translation module 230 may cause keyboard module 222 to display translations of words being entered via graphical keyboard 116B.

For example, translation module 230 may receive as input, textual information indicative of one or more candidate words determined by spatial model 226 and language model 228 in response to user input at graphical keyboard 116B. Translation module 230 may use translation models, lookup table, and other translation systems to determine a translation, from a source language to a destination language, of the one or more candidate words indicated by the textual information. Said differently, translation module 230 may translate the candidate words from their source language to a destination language that is different than the source language.

The translation models, lookup tables, and other translation systems used by translation module 230 may be integrated into keyboard module 222. In other words, while in some examples translation module 230 may rely on a model or translation system that is accessible via a remote computing device (e.g., a cloud service), translation module 230 may also perform on-device translations without relying on remote devices and/or services to perform the translation. By relying on models, lookup tables, and other translation systems that are stored locally to computing device 210 (e.g., at storage devices 248), translation module 230 may perform translations and present graphical translations at PSD 212 more quickly, in some examples, seemingly in real-time as a user taps or gestures at keyboard 116B.

Translation module 230 may automatically identify the source language and/or destination language by at least identifying one or more of the candidate words received as input, as being associated with a particular language. In cases where the one or more candidate words are utilized across multiple different languages, translation module 230 may determine the source language as being the language typically used or selected by the user of computing device 210, when composing text at graphical keyboard 116B. Translation module 230 may automatically identify the destination language by as being the language typically used or selected by the user of computing device 210, when requesting translations of text being composed at graphical keyboard 116B. In some examples, translation module 230 may determine the source language and/or destination language as being a language associated with the keyboard layout of graphical keyboard 116B. And in some examples, translation module 230 may default to using the last source and/or destination language used when translation module 230 was last invoked. In other words, translation module 230 may determine, based on previous destination languages used in prior translations, the destination language.

In some examples, translation module 230 may determine the source and/or destination language based on a user selectable setting (e.g., from an options menu of computing device 210) or from inputs at selectable element 118C of user interface 114. For example, translation module 230 may configure selectable element 118C to be a user selectable feature for selecting the source language and/or destination language for translations. In some examples, translation module 230 may change, based on a selection of selectable element 118C, the destination language from a first destination language to a second 1 destination language different from the first destination language and the source language. And in some examples, translation module 230 may change, based on a selection of selectable element 118C, the source language from a first source language to a second source language different from the first source language and the destination language. Translation module 230 may determine the destination and source languages using a combination of the aforementioned techniques.

In any case, translation module 230 may update a prior translation determined based on a selection of keys 118A in response to a change in destination and/or source language. For example, translation module 230 may update the translation of a candidate word from a first destination language to a second destination language after changing the destination language in response to the selection of selectable element 118C.

Keyboard module 222 may rely on a model built on one or more rules and/or machine learning techniques to determine that a user may wish to translate a candidate word based on location information, information about a sender and/or recipient of a message, or other contextual information. Throughout the disclosure, examples are described where a computing device and/or a computing system analyzes information (e.g., context, locations, speeds, search queries, etc.) associated with a computing device and a user of a computing device, only if the computing device receives permission from the user of the computing device to analyze the information. For example, in situations discussed below, before a computing device or computing system can collect or may make use of information associated with a user, the user may be provided with an opportunity to provide input to control whether programs or features of the computing device and/or computing system can collect and make use of user information (e.g., information about a user's current location, current speed, etc.), or to dictate whether and/or how to the device and/or system may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

As an example of automatically translating and selecting a destination/source language, keyboard module 222 may receive location information from a sensor of input components 244 or a radio receiver of communication units 242 (e.g., a GPS sensor or receiver) and infer from the location information, a current location of computing device 210. Keyboard module 222 may input the location into a model for determining languages most likely used in various regions of the word and receive an indication from the model of the most likely language that is spoken in the current location. In response to keyboard module 222 determining that the current location is in a geographical region that is not associated with a language typically used by the user of computing device 210 when the user enters text at graphical keyboard 116C, keyboard module 222 may automatically invoke translation module 230. Keyboard module 222 may determine, based on a current location of computing device 210, the destination language and cause translation module 230 to automatically display the translations at translation region 118B in a destination language that is associated with the current location.

By automatically invoking translation module 230 and determining the destination language to use, keyboard module 222 may cause PSD 212 to present, while a user provides input at graphical keyboard 116, translations inferred from the input in a language that is associated with a current location. For example, if a user of computing device 210 travels to the country of Denmark, and the user of computing device 210 typically interacts with computing device 210 using the English language, keyboard module 22 may cause translation module 230 to automatically present Danish translations at translation region 118B of the English words keyboard module 222 determines based on user input at graphical keyboard 116B.

Keyboard module 222 may receive message information from application modules 224 and infer from the message information whether a user may wish to translate candidate words and in what particular destination language. For example, if keyboard module 222 is providing graphical keyboard functionality to a chat application (e.g., one of application modules 224), keyboard module 222 may obtain information about messages received by the chat application and messages sent using the chat application. The message information may include text from the messages and/or meta data about the message (e.g., locations, times, recipient or sender locations, recipient or sender addresses, etc.). If a user is replying to a received message, keyboard module 222 may rely on a model or one or more rules for determining a destination language to use by inferring the language of the text within the received message. In other words, keyboard module 222 may input portions of the text into the model and determine a destination language that would most likely be associated with the text. Likewise, keyboard module may determine a destination language to use by inferring the language associated with an address or location of a sender of the received message and other information associated with messages being sent and received by computing device 220

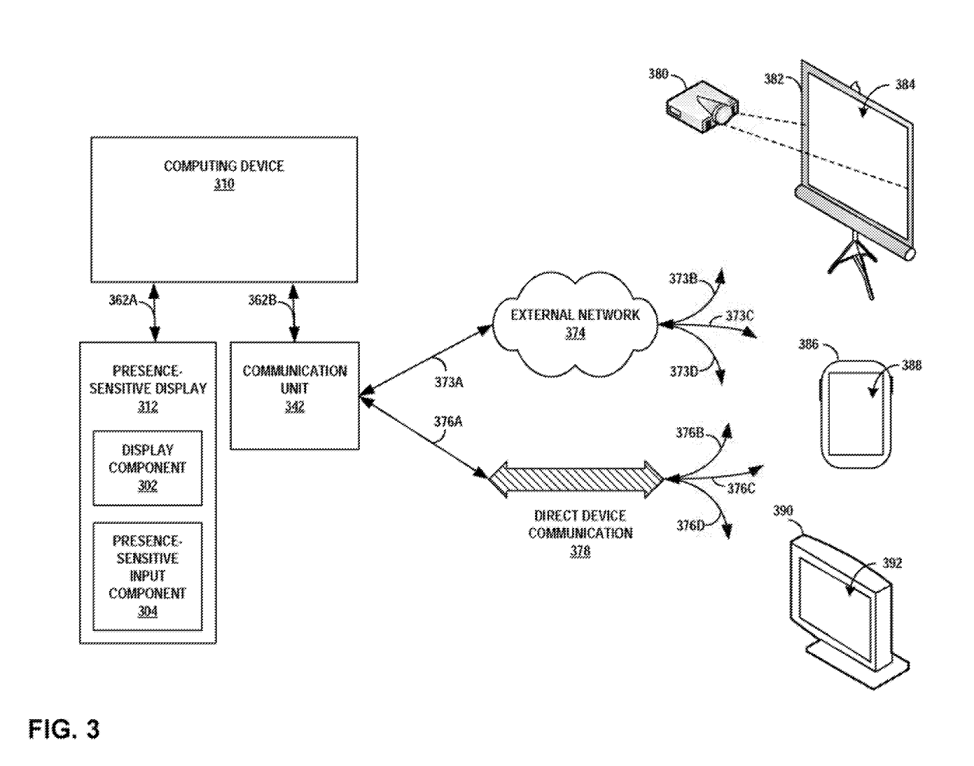

FIG. 3 is a block diagram illustrating an example computing device that outputs graphical content for display at a remote device, in accordance with one or more techniques of the present disclosure. Graphical content, generally, may include any visual information that may be output for display, such as text, images, a group of moving images, to name only a few examples. The example shown in FIG. 3 includes a computing device 310, a PSD 312, communication unit 342, projector 380, projector screen 382, mobile device 386, and visual display component 390. In some examples, PSD 312 may be a presence-sensitive display as described in FIGS. 1-2. Although shown for purposes of example in FIGS. 1 and 2 as a stand-alone computing device 110, a computing device such as computing device 310 may, generally, be any component or system that includes a processor or other suitable computing environment for executing software instructions and, for example, need not include a presence-sensitive display.

As shown in the example of FIG. 3, computing device 310 may be a processor that includes functionality as described with respect to processors 240 in FIG. 2. In such examples, computing device 310 may be operatively coupled to PSD 312 by a communication channel 362A, which may be a system bus or other suitable connection. Computing device 310 may also be operatively coupled to communication unit 342, further described below, by a communication channel 362B, which may also be a system bus or other suitable connection. Although shown separately as an example in FIG. 3, computing device 310 may be operatively coupled to PSD 312 and communication unit 342 by any number of one or more communication channels.

In other examples, such as illustrated previously by computing device 110 in FIGS. 1-2, a computing device may refer to a portable or mobile device such as mobile phones (including smart phones), laptop computers, etc. In some examples, a computing device may be a desktop computer, tablet computer, smart television platform, camera, personal digital assistant (PDA), server, or mainframes.

PSD 312 may include display component 302 and presence-sensitive input component 304. Display component 302 may, for example, receive data from computing device 310 and display the graphical content. In some examples, presence-sensitive input component 304 may determine one or more user inputs (e.g., continuous gestures, multi-touch gestures, single-touch gestures) at PSD 312 using capacitive, inductive, and/or optical recognition techniques and send indications of such user input to computing device 310 using communication channel 362A. In some examples, presence-sensitive input component 304 may be physically positioned on top of display component 302 such that, when a user positions an input unit over a graphical element displayed by display component 302, the location at which presence-sensitive input component 304 corresponds to the location of display component 302 at which the graphical element is displayed.

As shown in FIG. 3, computing device 310 may also include and/or be operatively coupled with communication unit 342. Communication unit 342 may include functionality of communication unit 242 as described in FIG. 2. Examples of communication unit 342 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 310 may also include and/or be operatively coupled with one or more other devices (e.g., input devices, output components, memory, storage devices) that are not shown in FIG. 3 for purposes of brevity and illustration.

FIG. 3 also illustrates a projector 380 and projector screen 382. Other such examples of projection devices may include electronic whiteboards, holographic display components, and any other suitable devices for displaying graphical content. Projector 380 and projector screen 382 may include one or more communication units that enable the respective devices to communicate with computing device 310. In some examples, the one or more communication units may enable communication between projector 380 and projector screen 382. Projector 380 may receive data from computing device 310 that includes graphical content. Projector 380, in response to receiving the data, may project the graphical content onto projector screen 382. In some examples, projector 380 may determine one or more user inputs (e.g., continuous gestures, multi-touch gestures, single-touch gestures) at projector screen using optical recognition or other suitable techniques and send indications of such user input using one or more communication units to computing device 310. In such examples, projector screen 382 may be unnecessary, and projector 380 may project graphical content on any suitable medium and detect one or more user inputs using optical recognition or other such suitable techniques.

Projector screen 382, in some examples, may include a presence-sensitive display 384. Presence-sensitive display 384 may include a subset of functionality or all of the functionality of presence-sensitive display 112 and/or 312 as described in this disclosure. In some examples, presence-sensitive display 384 may include additional functionality. Projector screen 382 (e.g., an electronic whiteboard), may receive data from computing device 310 and display the graphical content. In some examples, presence-sensitive display 384 may determine one or more user inputs (e.g., continuous gestures, multi-touch gestures, single-touch gestures) at projector screen 382 using capacitive, inductive, and/or optical recognition techniques and send indications of such user input using one or more communication units to computing device 310.

FIG. 3 also illustrates mobile device 386 and visual display component 390. Mobile device 386 and visual display component 390 may each include computing and connectivity capabilities. Examples of mobile device 386 may include e-reader devices, convertible notebook devices, hybrid slate devices, etc. Examples of visual display component 390 may include other devices such as televisions, computer monitors, etc. In some examples, visual display component 390 may be a vehicle cockpit display or navigation display (e.g., in an automobile, aircraft, or some other vehicle). In some examples, visual display component 390 may be a home automation display or some other type of display that is separate from computing device 310.

As shown in FIG. 3, mobile device 386 may include a presence-sensitive display 388. Visual display component 390 may include a presence-sensitive display 392. Presence-sensitive displays 388, 392 may include a subset of functionality or all of the functionality of presence-sensitive display 112, 212, and/or 312 as described in this disclosure. In some examples, presence-sensitive displays 388, 392 may include additional functionality. In any case, presence-sensitive display 392, for example, may receive data from computing device 310 and display the graphical content. In some examples, presence-sensitive display 392 may determine one or more user inputs (e.g., continuous gestures, multi-touch gestures, single-touch gestures) at projector screen using capacitive, inductive, and/or optical recognition techniques and send indications of such user input using one or more communication units to computing device 310.

As described above, in some examples, computing device 310 may output graphical content for display at PSD 312 that is coupled to computing device 310 by a system bus or other suitable communication channel. Computing device 310 may also output graphical content for display at one or more remote devices, such as projector 380, projector screen 382, mobile device 386, and visual display component 390. For instance, computing device 310 may execute one or more instructions to generate and/or modify graphical content in accordance with techniques of the present disclosure. Computing device 310 may output the data that includes the graphical content to a communication unit of computing device 310, such as communication unit 342. Communication unit 342 may send the data to one or more of the remote devices, such as projector 380, projector screen 382, mobile device 386, and/or visual display component 390. In this way, computing device 310 may output the graphical content for display at one or more of the remote devices. In some examples, one or more of the remote devices may output the graphical content at a presence-sensitive display that is included in and/or operatively coupled to the respective remote devices.

In some examples, computing device 310 may not output graphical content at PSD 312 that is operatively coupled to computing device 310. In other examples, computing device 310 may output graphical content for display at both a PSD 312 that is coupled to computing device 310 by communication channel 362A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 310 and output for display at PSD 312 may be different than graphical content display output for display at one or more remote devices.

Computing device 310 may send and receive data using any suitable communication techniques. For example, computing device 310 may be operatively coupled to external network 374 using network link 373A. Each of the remote devices illustrated in FIG. 3 may be operatively coupled to network external network 374 by one of respective network links 373B, 373C, or 373D. External network 374 may include network hubs, network switches, network routers, etc., that are operatively inter-coupled thereby providing for the exchange of information between computing device 310 and the remote devices illustrated in FIG. 3. In some examples, network links 373A-373D may be Ethernet, ATM or other network connections. Such connections may be wireless and/or wired connections.

In some examples, computing device 310 may be operatively coupled to one or more of the remote devices included in FIG. 3 using direct device communication 378. Direct device communication 378 may include communications through which computing device 310 sends and receives data directly with a remote device, using wired or wireless communication. That is, in some examples of direct device communication 378, data sent by computing device 310 may not be forwarded by one or more additional devices before being received at the remote device, and vice-versa. Examples of direct device communication 378 may include Bluetooth, Near-Field Communication, Universal Serial Bus, WiFi, infrared, etc. One or more of the remote devices illustrated in FIG. 3 may be operatively coupled with computing device 310 by communication links 376A-376D. In some examples, communication links 376A-376D may be connections using Bluetooth, Near-Field Communication, Universal Serial Bus, infrared, etc. Such connections may be wireless and/or wired connections.

In accordance with techniques of the disclosure, computing device 310 may be operatively coupled to visual display component 390 using external network 374. Computing device 310 may output, for display at PSD 312, a graphical user interface including an edit region and a graphical keyboard the graphical keyboard including a plurality of keys and a translation region. For instance, computing device 310 may send data that includes a representation of the graphical user interface to communication unit 342. Communication unit 342 may send the data that includes the representation of the graphical user interface to visual display component 390 using external network 374. Visual display component 390, in response to receiving the data using external network 374, may cause PSD 312 to output the graphical user interface. In response to receiving a user input at PSD 312 to select one or more keys of the keyboard of the graphical user interface, visual display device 130 may send an indication of the selection of the one or more keys to computing device 310 using external network 374. Communication unit 342 of may receive the indication of the selection of the one or more keys, and send the indication of the selection of the one or more keys to computing device 310.

While receiving the indication of the selection of the one or more keys, computing device 310 may output, for display within the edit region of the graphical user interface, one or more candidate words inferred from the selection, wherein the one or more candidate words are associated with a source language, determine a translation of a particular word from the one or more candidate words, the translation of the particular word being associated with a destination language that is different than the source language, and output, for display within the translation region of the graphical keyboard, an indication of the translation. For example, computing device 310 may send an updated representation of the graphical user interface that includes the one or more candidate words within the edit region and the translation within the translation region of the graphical keyboard. Communication unit 342 may receive the representation of the updated graphical user interface and may send the updated representation to visual display component 390, such that visual display component 390 may cause PSD 312 to output the updated graphical user interface, including the translation displayed within the translation region of the graphical keyboard.

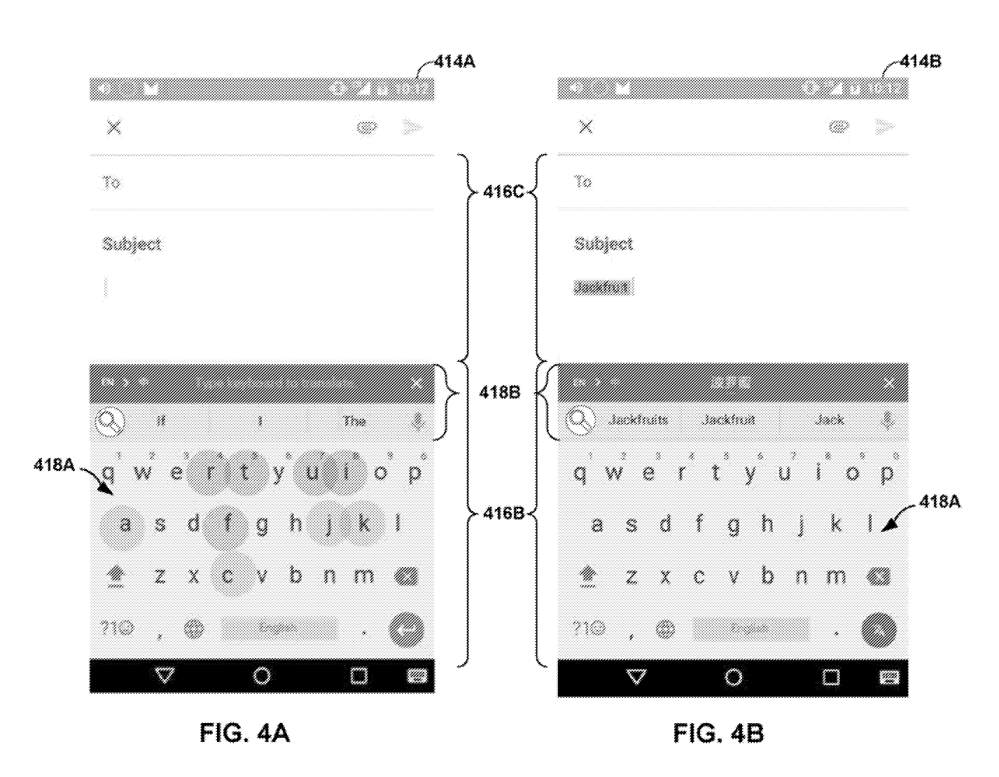

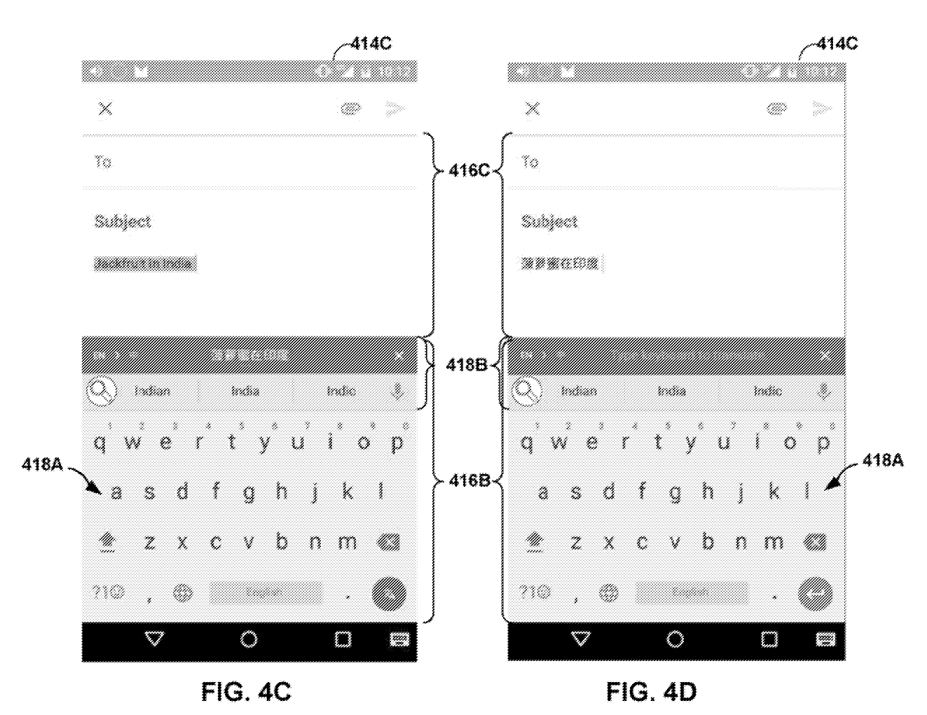

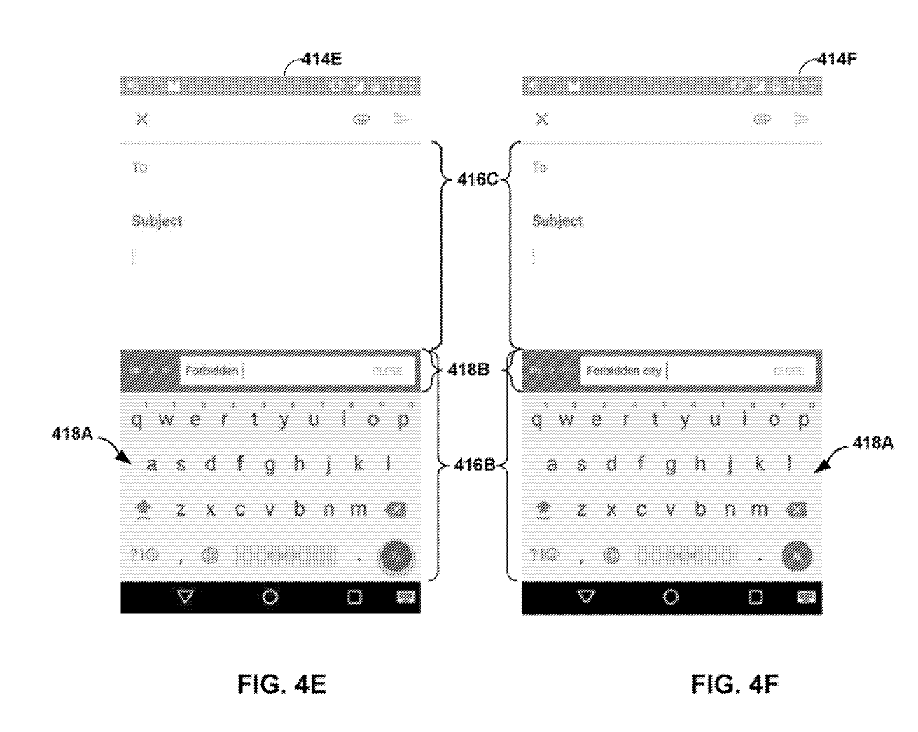

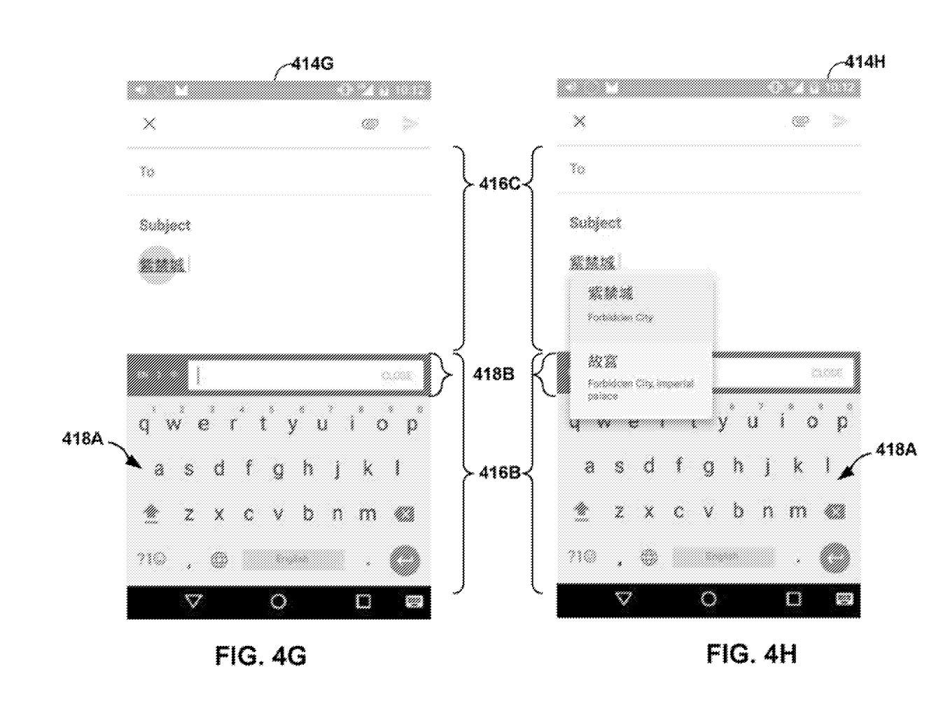

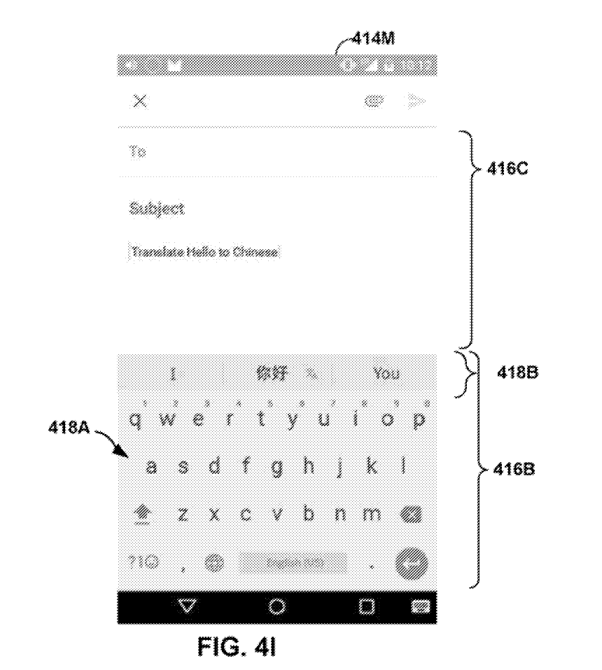

FIGS. 4A-4I are conceptual diagrams illustrating example graphical user interfaces of an example computing device that is configured to present a graphical keyboard with integrated translation features, in accordance with one or more aspects of the present disclosure. FIGS. 4A-4I illustrate, respectively, example graphical user interfaces 414A-414I (collectively, user interfaces 414). However, many other examples of graphical user interfaces 414 may be used in other instances. Each of graphical user interfaces 414 may correspond to a graphical user interface displayed by computing devices 110 or 210 of FIGS. 1 and 2 respectively. Each of user interfaces 414 includes graphical keyboard 416B and edit region 416C. Graphical keyboard 416B, in each of user interfaces 414, includes suggestion/translation region 418B and graphical keys 418A. FIGS. 4A-4I are described below in the context of computing device 110.

In the example of FIGS. 4A-4D, user interfaces 414A-414D show how in some examples, computing device 110 may cause graphical indications of translations to be output for display while a user of computing device 110 is providing input at graphical keyboard 416B. For example, as shown in FIG. 4A, a user may provide tap inputs at or near the locations of various keys 418A. In response to the tap inputs at keys 418A, computing device 110 may automatically display, within suggestion/translation region 418B, one or more candidate words (e.g., Jackfruits, Jackfruit, Jack, etc.) determined from the input in a source language (e.g., English) and also display within suggestion/translation region 418B, a translation of the most likely candidate word (Jackfruit) in a destination language (e.g., Chinese). Computing device 110 may further display, within edit region 416C, the most likely candidate word (Jackfruit) in the source language.

Next, as shown in FIG. 4C, a user of computing device 110 may continue to provide input at keys 418A causing computing device 110 to automatically display, within suggestion/translation region 418B, one or more additional candidate words (e.g., Indian, India, Indic, etc.) determined from the input in the source language and also display within suggestion/translation region 418B, a translation of the most likely candidate words (Jackfruit in India) in the destination language that have been determined since the user began typing. Computing device 110 may further display, within edit region 416C, the most likely candidate words in the source language.

Next, as shown in FIG. 4D, a user of computing device 110 may determine that a user has selected the graphical indication of the translation displayed within suggestion/translation region 418B and in response to determining that the user has selected the translation, computing device 110 may replace the indication of the at least one candidate word within edit region 416C with the indication of the translation. For example, as shown in FIG. 4D, the Chinese phrase “ [symbol] [symbol] ” has replaced the English phrase “Jackfruit in India”.

In some examples, prior to receiving the indication of the selection of the translation, computing device 110 may display the indication of at least one candidate word in a first visual format within the edit region 416C and indications of other words may be displayed in a second visual format within the edit region 416C. In other words, computing device 110 may highlight (e.g., with coloring, underlining, etc.) a candidate word or phrase within edit region 416C that has been translated and displayed within suggestion/translation region 418B.

In some examples, prior to receiving the indication of the selection of the translation, computing device 110 may display the indication of at least one candidate word in a first visual format within the edit region 416C and may display the indication of the translation in a second visual format the edit region 416C. In other words, computing device 110 may highlight (e.g., with coloring, underlining, etc.) a candidate word or phrase within edit region 416C that has been translated and displayed within suggestion/translation region 418B and remove the highlighting when the translation replaces the candidate word or phrase.

In the example of FIGS. 4E-4H, user interfaces 414E-414H show how in some examples, computing device 110 may display a confirmation window after a user selects a translation that has replaced a candidate word in edit region 416C. For example, as shown in FIGS. 4A-4B, a user may provide tap inputs at or near the locations of various keys 418A. In response to the tap inputs at keys 418A, computing device 110 may automatically display, within suggestion/translation region 418B, one or more candidate words (e.g., Forbidden city) determined from the input in a source language (e.g., English).

As shown in FIG. 4G, upon detecting that the user of computing device 110 selected the return key of graphical keyboard 416B, computing device 110 may input a translation of the one or more candidate words determined from the input in edit region 416C. As shown in FIG. 4H, upon detecting that the user of computing device 110 selected the graphical indication of the translation within edit region 416C, computing device 110 may display a popup that provides alternative translations from which a user may select to replace the current translation.

In some examples, computing device 110 may determine, based on the selection of one or more keys 418A, a user command to perform translations and may output an indication of a translation for display within translation region 418B in response to determining the user command to perform translations. For example, as shown in FIG. 4I, the user has selected various keys 418A of graphical keyboard 416B that computing device 110 has recognized as the phrase “Translate Hello to Chinese”. In response to computing device 110 determining that the phrase is a command to perform a translation, computing device 110 displays, within suggestion/translation region 418B, a graphical indication of the Chinese translation of the English word “Hello”. In some examples, computing device 110 may display indications of translations interspersed with candidate words. For example, as further shown in FIG. 4I, computing device 110 may display the translation of the word “Hello” in between candidate words “I” and “You” that computing device 110 determines are the most likely candidate words the user will want to input next.

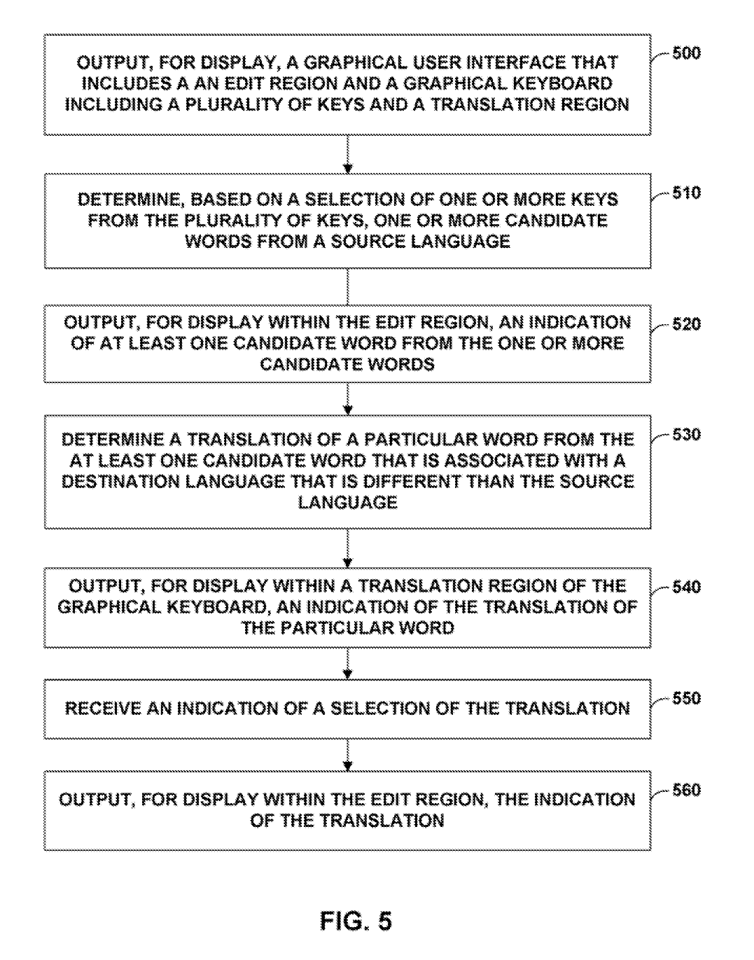

FIG. 5 is a flowchart illustrating example operations of a computing device that is configured to present a graphical keyboard with integrated search features, in accordance with one or more aspects of the present disclosure. The operations of FIG. 5 may be performed by one or more processors of a computing device, such as computing devices 110 of FIG.1 or computing device 210 of FIG. 2. For purposes of illustration only, FIG. 5 is described below within the context of computing devices 110 of FIGS. 1A-1C.

In operation, computing device 110 may output, for display, a graphical user interface that includes an edit region and a graphical keyboard including a plurality of keys and a translation region (500). For example, computing device 110 may cause PSD 112 to present user interface 114A including graphical keyboard 116B and edit region 116C. Graphical keyboard 116B may include keys 118A and translation region 118B.

Computing device 110 may determine, based on a selection of one or more keys from the plurality of keys, one or more candidate words from a source language (510). For example, a user may provide tap and/or gesture input at or near locations of PSD 112 at which keys 118A are displayed. A language and/or spatial model of keyboard module 122 may determine, based on touch events received from UI module 120 and PSD 112, one or more words in a Chinese language lexicon that a user may be entering based on the input at PSD 112.

Computing device 110 may output, for display within the edit region, an indication of at least one candidate word from the one or more candidate words (520). For example, keyboard module 122 may determine the candidate word with the highest score or likelihood of being selected based on the touch events and cause UI module 120 to present the word, written in Chinese characters, at PSD 112 within edit region 116C.

Computing device 110 may determine a translation of a particular word from the at least one candidate word, the translation of the particular word being associated with a destination language that is different than the source language (530). For example, in response to determining that computing device 110 is located in Australia, rather than China, keyboard module 122 may automatically invoke a translation feature of keyboard module 122 and translate the candidate word being displayed within edit region 116C into English characters.

Computing device 110 may output, for display within a translation region of the graphical keyboard, an indication of the translation of the particular word (540). For example, after translating the candidate word, keyboard module 122 may cause UI module 120 to present the English translation of the candidate word at PSD 112 and within translation region 118B.

Computing device 110 may receive an indication of a selection of the translation (550). For example, a user of computing device 110 may tap or gesture at or near a location of PSD 112 at which the English translation of the candidate word is displayed.

Computing device 110 may output, for display within the edit region, the indication of the translation (560). For example, in response to receiving an indication of the input at the graphical indication of the English translation of the candidate word, keyboard module 122 may cause UI module 120 to replace the Chinese characters of the candidate word within edit region 116C with the English characters of the candidate word.

In some examples, computing device 110 may determine the translation of the particular word from the at least one candidate word in response to determining that the one or more candidate words are associated with the source language and not the destination language. Said differently, in some examples, computing device 110 may determine the translation of the particular word from the at least one candidate word in response to determining the source language changed from a first source language to a second source language, the first source language being the destination language.

For example, a user of computing device 110 may provide input at graphical keyboard 116B to input one or more words in his or her non-native language which may be English. If he or she does not know how to type a particular word in English, but does know how to type the particular word in Spanish, the user may provide input at graphical keyboard 116B to input the word in Spanish. Computing device 110 may automatically recognize that the user switched from typing English words to typing Spanish words and determine that the user likely wants to translate the Spanish word to English. Computing device 110 may automatically translate the Spanish word to English and output the English translation for display within suggestion region 118B and/or edit region 116C.

The following numbered clauses may illustrate one or more aspects of the disclosure:

Clause 1. A method comprising: outputting, by a computing device, for display, a graphical user interface that includes a graphical keyboard and an edit region, the graphical keyboard comprising a plurality of keys and a translation region; determining, by the computing device, based on a selection of one or more keys from the plurality of keys, one or more candidate words from a source language; outputting, by the computing device, for display within the edit region, an indication of at least one candidate word from the one or more candidate words; determining, by the computing device, a translation of a particular word from the at least one candidate word, the translation of the particular word being associated with a destination language that is different than the source language; and outputting, by the computing device, for display within a translation region of the graphical keyboard, an indication of the translation of the particular word.

Clause 2. The method of clause 1, wherein the graphical keyboard is output for display as part of an application graphical user interface, and wherein the application graphical user interface includes an edit region, the method further comprising, responsive to receiving an indication of a selection of the translation, outputting, by the computing device, for display within the edit region, the indication of the translation.

Clause 3. The method of clause 2, further comprising: prior to receiving the indication of the selection of the translation, outputting, by the computing device, for display within the edit region, an indication of the particular word in the source language, wherein outputting the indication of the translation within the edit region comprises replacing the indication of the at least one candidate word within the edit region with the indication of the translation.

Clause 4. The method of clause 3, wherein, prior to receiving the indication of the selection of the translation: the indication of at least one candidate word is displayed in a first visual format within the edit region; and indications of other words are displayed in a second visual format within the edit region, the second visual format being different than the first visual format.

Clause 5. The method of any of clauses 1-4, wherein the translation region includes a selectable element to select the destination language, the method further comprising: changing, by the computing device, based a selection of the selectable element for selecting the destination language, the destination language from a first language to a second language different from the first language and the source language; and updating, by the computing device, the translation of the at least one candidate word from the first language to the second language.

Clause 6. The method of any of clauses 1-5, further comprising: determining, by the computing device, based on a current location of the computing device, the destination language.

Clause 7. The method of any of clauses 1-6, further comprising: determining, by the computing device, based on an inferred language of a received message, the destination language.

Clause 8. The method of any of clauses 1-7, further comprising: determining, by the computing device, based on previous destination languages used in prior translations, the destination language.

Clause 9. The method of any of clauses 1-8, further comprising: determining, by the computing device, based on the selection of one or more keys, a user command to perform translations, wherein the indication of the translation is output for display within the translation region in response to determining the user command to perform translations.

Clause 10. The method of any of clauses 1-9, wherein the translation of the particular word from the at least one candidate word is determined in response to determining that the one or more candidate words are associated with the source language and not the destination language.

Clause 11. The method of any of clauses 1-10, wherein the translation of the particular word from the at least one candidate word is determined in response to determining the source language changed from a first source language to a second source language, the first source language being the destination language.

Clause 12. A mobile device comprising: a presence-sensitive display component; at least one processor; and a memory that stores instructions that when executed cause the at least one processor to: output, for display at the presence-sensitive display component, a graphical user interface that includes a graphical keyboard and an edit region, the graphical keyboard comprising a plurality of keys and a translation region; receive an indication of input detected at the presence-sensitive display component; determine one or more keys from the plurality of keys selected by the input; determine, based on the one or more keys, one or more candidate words from a source language; output, for display at the presence-sensitive display component and within the edit region, an indication of at least one candidate word from the one or more candidate words; determine a translation of a particular word from the at least one candidate word, the translation of the particular word being associated with a destination language that is different than the source language; and output, for display at the presence-sensitive display component and within the translation region, an indication of the translation of the particular word.

Clause 13. The mobile device of clause 12, wherein the instructions, when executed, further cause the at least one processor to responsive to receiving an indication of a selection of the translation, output, for display at the presence-sensitive display component and within the edit region, the indication of the translation.

Clause 14. The mobile device of clause 13, wherein the instructions, when executed, further cause the at least one processor to: prior to receiving the indication of the selection of the translation, output, for display at the presence-sensitive display component and within the edit region, an indication of the particular word in the source language, wherein the indication of the translation is output for display within the edit region by at least replacing the indication of the at least one candidate word within the edit region with the indication of the translation.

Clause 15. The mobile device of any of clauses 12-14, wherein, the instructions, when executed, further cause the at least one processor to: determine, based on a current location of the computing device, the destination language.

Clause 16. The mobile device of any of clauses 12-14, wherein, the instructions, when executed, further cause the at least one processor to: determine, based on an inferred language of a received message, the destination language.

Clause 17. The mobile device of any of clauses 12-14, wherein, the instructions, when executed, further cause the at least one processor to: determine, based on previous destination languages used in prior translations, the destination language.

Clause 18. The mobile device of any of clauses 12-14, wherein, the instructions, when executed, further cause the at least one processor to: determine, based on the selection of one or more keys, a user command to perform translations, wherein the indication of the translation is output for display within the translation region in response to determining the user command to perform translations.

Clause 19. A computer-readable storage medium comprising instructions that when executed cause at least one processor of a computing device to: output, for display, a graphical user interface that includes an edit region and a graphical keyboard, the graphical keyboard comprising a plurality of keys and a translation region; while receiving an indication of a selection of one or more keys from the plurality of keys, output, for display within the region, one or more candidate words inferred from the selection, wherein the one or more candidate words are associated with a source language; determine a translation of a particular word from the one or more candidate words, the translation of the particular word being associated with a destination language that is different than the source language; and output, for display within the translation region, an indication of the translation.

Clause 20. The computer-readable storage medium of clause 19, wherein the translation is a first translation, the computer-readable storage medium comprising additional instructions that when executed cause the at least one processor of the computing device to: responsive to receiving an indication of a selection of the first translation, output, for display, one or more second translations of the particular word from the one or more candidate words; and responsive to receiving an indication of a selection of a particular second translation from the one or more second translations, replace, within the edit region, the indication of the first translation with an indication of the particular second translation.

Clause 21. A system comprising means for performing any of the methods of clauses 1-11.

Clause 22. A computing device comprising means for performing any of the methods of clauses 1-11.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by a computing device, for display, a graphical user interface that includes a graphical keyboard and an edit region, the graphical keyboard comprising a plurality of keys and a translation region;
determining, by the computing device, based on a selection of one or more keys from the plurality of keys, one or more candidate words from a source language;
outputting, by the computing device, for display within the edit region, an indication of at least one candidate word from the one or more candidate words;
determining, by the computing device, a translation of a particular word from the at least one candidate word, the translation of the particular word being associated with a destination language that is different than the source language; and
outputting, by the computing device, for display within a translation region of the graphical keyboard, an indication of the translation of the particular word.

2. The method of claim 1, wherein the graphical keyboard is output for display as part of an application graphical user interface, and wherein the application graphical user interface includes an edit region, the method further comprising, responsive to receiving an indication of a selection of the translation, outputting, by the computing device, for display within the edit region, the indication of the translation.

3. The method of claim 2, further comprising:
prior to receiving the indication of the selection of the translation, outputting, by the computing device, for display within the edit region, an indication of the particular word in the source language,
wherein outputting the indication of the translation within the edit region comprises replacing the indication of the at least one candidate word within the edit region with the indication of the translation.

4. The method of claim 3, wherein, prior to receiving the indication of the selection of the translation:
the indication of at least one candidate word is displayed in a first visual format within the edit region; and
indications of other words are displayed in a second visual format within the edit region, the second visual format being different than the first visual format.

5. The method of claim 1, wherein the translation region includes a selectable element to select the destination language, the method further comprising:
changing, by the computing device, based a selection of the selectable element for selecting the destination language, the destination language from a first language to a second language different from the first language and the source language; and
updating, by the computing device, the translation of the at least one candidate word from the first language to the second language.

6. The method of claim 1, further comprising:
determining, by the computing device, based on a current location of the computing device, the destination language.

7. The method of claim 1, further comprising:
determining, by the computing device, based on an inferred language of a received message, the destination language.

8. The method of claim 1, further comprising:
determining, by the computing device, based on previous destination languages used in prior translations, the destination language.

9. The method of claim 1, further comprising:
determining, by the computing device, based on the selection of one or more keys, a user command to perform translations, wherein the indication of the translation is output for display within the translation region in response to determining the user command to perform translations.

10. The method of claim 1, wherein the translation of the particular word from the at least one candidate word is determined in response to determining that the one or more candidate words are associated with the source language and not the destination language.

11. The method of claim 1, wherein the translation of the particular word from the at least one candidate word is determined in response to determining the source language changed from a first source language to a second source language, the first source language being the destination language.

12. A mobile device comprising:
a presence-sensitive display component;
at least one processor; and
a memory that stores instructions that when executed cause the at least one processor to:
output, for display at the presence-sensitive display component, a graphical user interface that includes a graphical keyboard and an edit region, the graphical keyboard comprising a plurality of keys and a translation region;
receive an indication of input detected at the presence-sensitive display component;
determine one or more keys from the plurality of keys selected by the input;
determine, based on the one or more keys, one or more candidate words from a source language;
output, for display at the presence-sensitive display component and within the edit region, an indication of at least one candidate word from the one or more candidate words;
determine a translation of a particular word from the at least one candidate word, the translation of the particular word being associated with a destination language that is different than the source language; and
output, for display at the presence-sensitive display component and within the translation region, an indication of the translation of the particular word.

13. The mobile device of claim 12, wherein the instructions, when executed, further cause the at least one processor to responsive to receiving an indication of a selection of the translation, output, for display at the presence-sensitive display component and within the edit region, the indication of the translation.

14. The mobile device of claim 13, wherein the instructions, when executed, further cause the at least one processor to:
prior to receiving the indication of the selection of the translation, output, for display at the presence-sensitive display component and within the edit region, an indication of the particular word in the source language,
wherein the indication of the translation is output for display within the edit region by at least replacing the indication of the at least one candidate word within the edit region with the indication of the translation.

15. The mobile device of claim 12, wherein, the instructions, when executed, further cause the at least one processor to:
determine, based on a current location of the computing device, the destination language.

16. The mobile device of claim 12, wherein, the instructions, when executed, further cause the at least one processor to:
determine, based on an inferred language of a received message, the destination language.

17. The mobile device of claim 12, wherein, the instructions, when executed, further cause the at least one processor to:
determine, based on previous destination languages used in prior translations, the destination language.

18. The mobile device of claim 12, wherein, the instructions, when executed, further cause the at least one processor to:
determine, based on the selection of one or more keys, a user command to perform translations, wherein the indication of the translation is output for display within the translation region in response to determining the user command to perform translations.

19. A computer-readable storage medium comprising instructions that when executed cause at least one processor of a computing device to:
output, for display, a graphical user interface that includes an edit region and a graphical keyboard, the graphical keyboard comprising a plurality of keys and a translation region;
while receiving an indication of a selection of one or more keys from the plurality of keys, output, for display within the region, one or more candidate words inferred from the selection, wherein the one or more candidate words are associated with a source language;
determine a translation of a particular word from the one or more candidate words, the translation of the particular word being associated with a destination language that is different than the source language; and
output, for display within the translation region, an indication of the translation.

20. The computer-readable storage medium of claim 19, wherein the translation is a first translation, the computer-readable storage medium comprising additional instructions that when executed cause the at least one processor of the computing device to:
responsive to receiving an indication of a selection of the first translation, output, for display, one or more second translations of the particular word from the one or more candidate words; and
responsive to receiving an indication of a selection of a particular second translation from the one or more second translations, replace, within the edit region, the indication of the first translation with an indication of the particular second translation.
